(19) United States
(12) Patent Application Publication
(10) Pub. No.: US 2024/0022357 A1
(43) Pub. Date: Jan. 18, 2024

(54) TECHNIQUES FOR HYBRID AUTOMATIC REPEAT REQUEST STATE DISCARDING

(71) Applicant: QUALCOMM Incorporated, San Diego, CA (US)

(72) Inventors: Arnaud MEYLAN, San Diego, CA (US); Levent AYDIN, San Diego, CA (US); Ashok MANTRAVADI, San Diego, CA (US); Brian Clarke BANISTER, San Diego, CA (US); Leena ZACHARIAS, San Jose, CA (US); Sitaramanjaneyulu KANAMARLAPUDI, San Diego, CA (US); Hobin KIM, San Diego, CA (US)

(21) Appl. No.: 18/352,047

(22) Filed: Jul. 13, 2023

Related U.S. Application Data
(60) Provisional application No. 63/368,466, filed on Jul. 14, 2022.

(51) Int. Cl. H04L 1/1829; H04W 72/232; H04W 76/28

(52) U.S. Cl. CPC H04L 1/1848; H04W 72/232; H04L 1/1854; H04W 76/28

(57) ABSTRACT

Various aspects of the present disclosure generally relate to wireless communication. In some aspects, a user equipment (UE) may receive a first physical downlink control channel (PDCCH) communication having a new data indicator (NDI) value for a hybrid automatic repeat request (HARQ) process. The UE may start a HARQ state discard timer based at least in part on receiving the first PDCCH communication, wherein a duration of the HARQ state discard timer is based at least in part on one or more conditions. Numerous other aspects are described.

### CROSS-REFERENCE TO RELATED APPLICATION

This Patent application claims priority to U.S. Provisional Patent Application No. 63/368,466, filed on Jul. 14, 2022, entitled “TECHNIQUES FOR HYBRID AUTOMATIC REPEAT REQUEST STATE DISCARDING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for hybrid automatic repeat request (HARQ) state discarding.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a first physical downlink control channel (PDCCH) communication having a new data indicator (NDI) value for a hybrid automatic repeat request (HARQ) process. The method may include starting a HARQ state discard timer based at least in part on receiving the first PDCCH communication, where a duration of the HARQ state discard timer is based at least in part on one or more conditions.

Some aspects described herein relate to a UE for wireless communication. The UE may include a memory and one or more processors coupled to the memory. The one or more processors may be configured to receive a first PDCCH communication having an NDI value for a HARQ process. The one or more processors may be configured to start a HARQ state discard timer based at least in part on receiving the first PDCCH communication, where a duration of the HARQ state discard timer is based at least in part on one or more conditions.

Some aspects described herein relate to a non-transitory computer-readable medium that stores a set of instructions for wireless communication by a UE. The set of instructions, when executed by one or more processors of the UE, may cause the UE to receive a first PDCCH communication having an NDI value for a HARQ process. The set of instructions, when executed by one or more processors of the UE, may cause the UE to start a HARQ state discard timer based at least in part on receiving the first PDCCH communication, where a duration of the HARQ state discard timer is based at least in part on one or more conditions.

Some aspects described herein relate to an apparatus for wireless communication. The apparatus may include means for receiving a first PDCCH communication having an NDI value for a HARQ process. The apparatus may include means for starting a HARQ state discard timer based at least in part on receiving the first PDCCH communication, where a duration of the HARQ state discard timer is based at least in part on one or more conditions.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIGS. 3A and 3B are diagrams illustrating an example associated with hybrid automatic repeat request (HARQ) state discarding, in accordance with the present disclosure.

FIG. 3B is a diagram illustrating an example in which the UE processes a shared channel communication as a new transmission based at least in part on a second physical downlink control channel (PDCCH) communication being received after an expiration of a HARQ state discard timer.

FIG. 4 is a diagram illustrating an example process performed, for example, by a UE, in accordance with the present disclosure.

FIG. 5 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

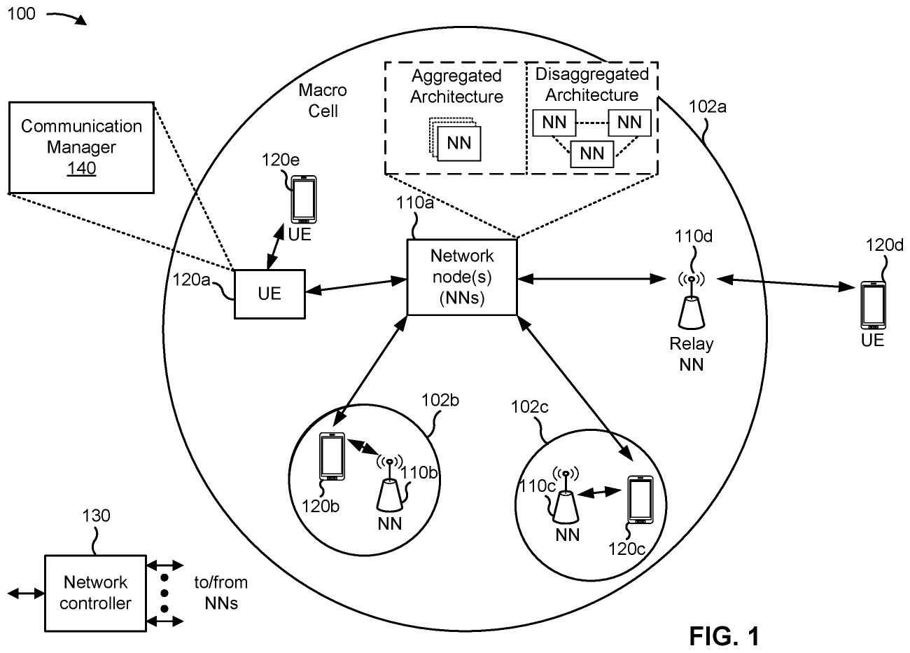

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a first physical downlink control channel (PDCCH) communication having a new data indicator (NDI) value for a hybrid automatic repeat request (HARQ) process; and start a HARQ state discard timer based at least in part on receiving the first PDCCH communication, wherein a duration of the HARQ state discard timer is based at least in part on one or more conditions. Additionally, or alternatively, the communication manager 140 may perform one or more other operations described herein.

As indicated above, FIG. 1 is provided as an example. Other examples may differ from what is described with regard to FIG. 1.

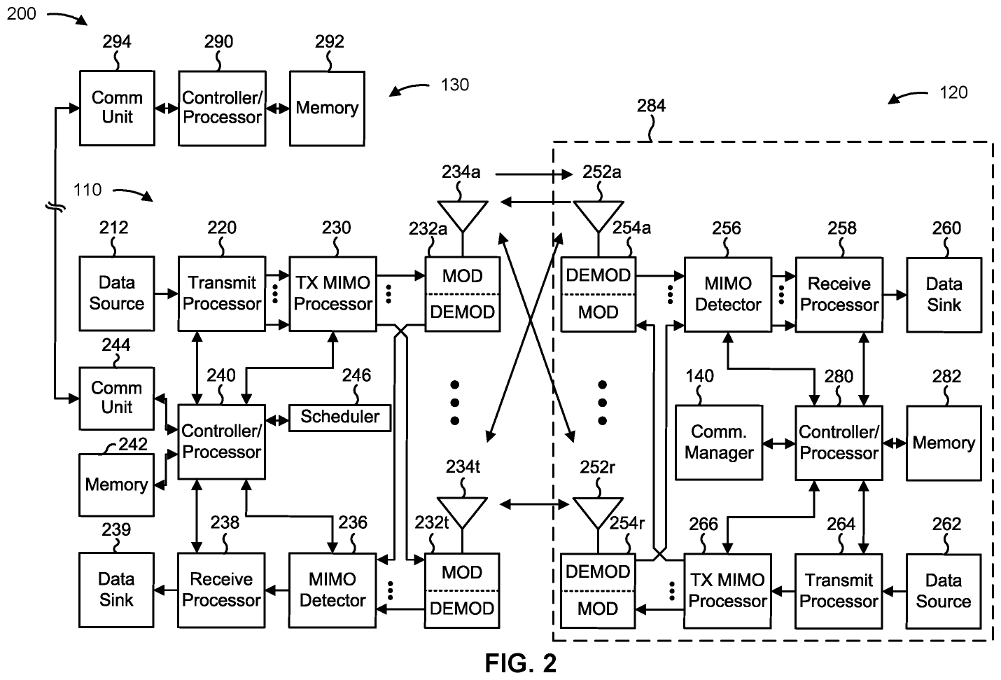

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

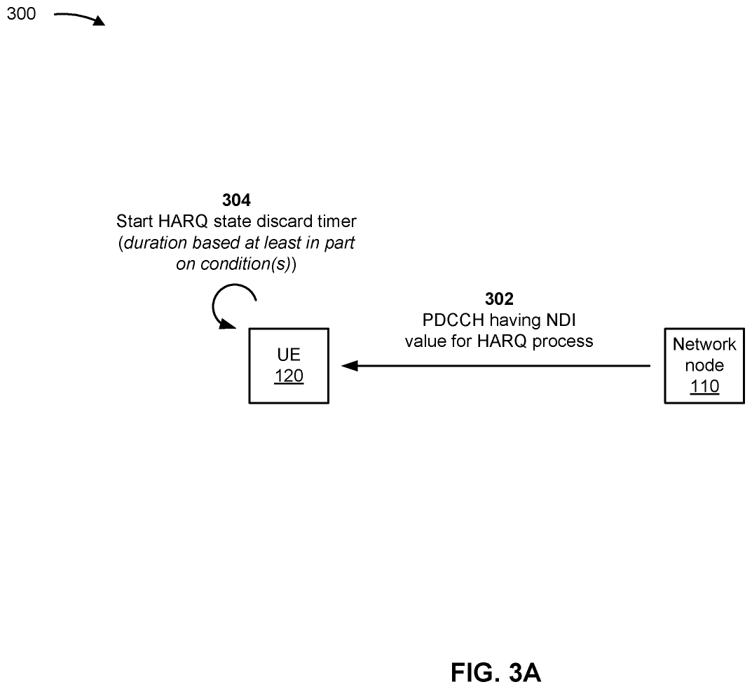

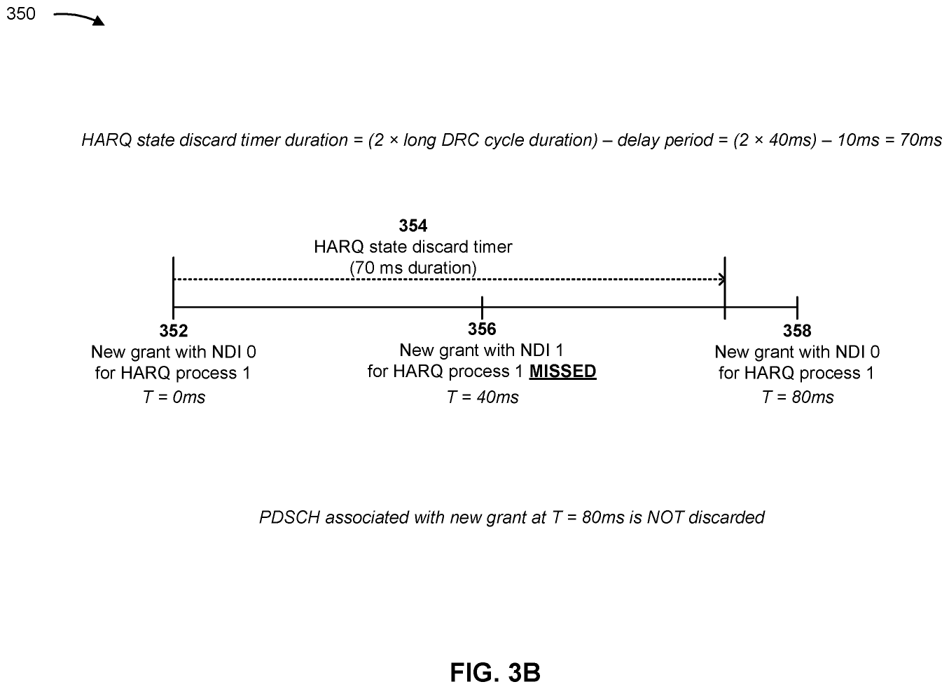

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 3A-5).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 3A-5).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

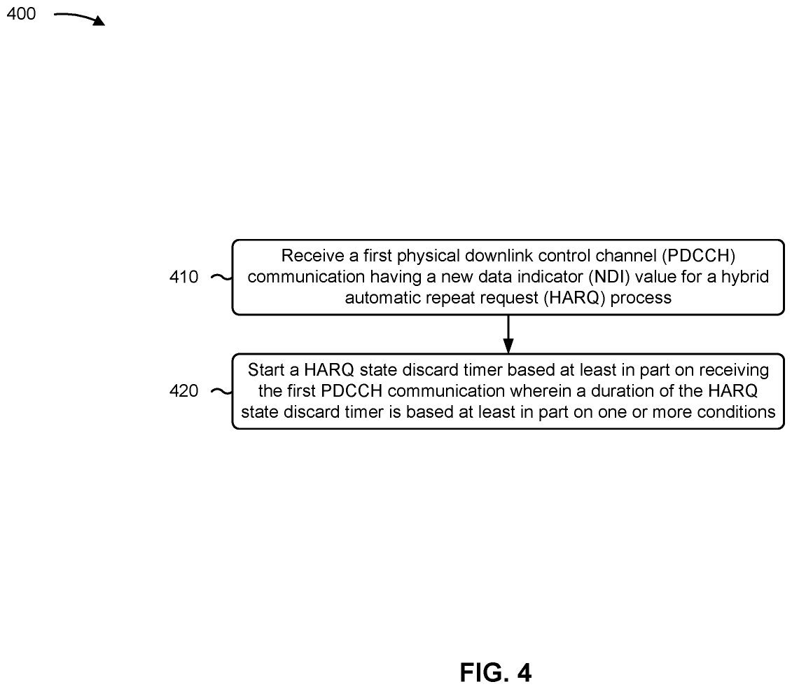

The controller/processor 240 of the network node 110, the controller/processor 280 of the UE 120, or any other component(s) of FIG. 2 may perform one or more techniques associated with HARQ state discarding, as described in more detail elsewhere herein. For example, the controller/processor 240 of the network node 110, the controller/processor 280 of the UE 120, or any other component(s) (or combinations of components) of FIG. 2 may perform or direct operations of, for example, process 400 of FIG. 4, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 400 of FIG. 4, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a first PDCCH communication having an NDI value for a HARQ process; and/or means for starting a HARQ state discard timer based at least in part on receiving the first PDCCH communication, wherein a duration of the HARQ state discard timer is based at least in part on one or more conditions. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

HARQ refers to a retransmission protocol in which a receiver wireless communication device checks for errors in received data and, if an error is detected, then the receiver wireless communication device buffers the received data and requests a retransmission from a transmitter wireless communication device. A HARQ receiver is then able to combine the buffered received data with retransmitted data prior to channel decoding and error detection, which improves performance of the retransmission. The HARQ protocol can be implemented at a medium access control (MAC) layer.

The HARQ protocol relies on the transmitter wireless communication device receiving acknowledgements (e.g., an acknowledgments (ACKs) or negative acknowledgments (NACKS)) from the receiver wireless communication device. The round trip time, which includes both a processing time of the transmitter wireless communication device and a processing time of the receiver wireless communication device as well as propagation delays, means that such acknowledgements are not received instantaneously.

In general, the transmitter wireless communication device becomes inactive (with respect to communicating with the receiver wireless communication device) while waiting for an acknowledgment or waiting for a scheduling opportunity, meaning that average throughput may be relatively low. This corresponds to a single HARQ process (also referred to as a stop and wait (SAW) process). A HARQ process stops and waits for an acknowledgment before proceeding to transfer additional data. Multiple HARQ processes can be used to avoid the round trip time having an impact on throughput. That is, other HARQ processes may transfer data while a given HARQ process is waiting for an acknowledgment. A HARQ entity within the MAC layer manages the multiple HARQ processes. In operation, the transmitter wireless communication device buffers transmitted data until a positive acknowledgment has been received (in case a retransmission is needed). Data is cleared from the transmit buffer once a positive acknowledgment has been received or the maximum number of allowed retransmissions has been reached. New data can be sent by a given HARQ process once its transmit buffer has been cleared.

The HARQ protocol can be used on the downlink or on the uplink “Downlink HARQ” may refer to the transfer of downlink data on a physical downlink shared channel (PDSCH) with HARQ acknowledgments returned either on a physical uplink control channel (PUCCH) or a physical uplink shared channel (PUSCH). “Uplink HARQ” may refer to the transfer of uplink data on a PUSCH with HARQ acknowledgments returned on a PDCCH. For both downlink HARQ and uplink HARQ, each serving cell has its own HARQ entity and its own set of HARQ processes. Further, both downlink HARQ and uplink HARQ are asynchronous, meaning that there is no fixed timing pattern for each HARQ process. Rather, a network node must signal an identity of a relevant HARQ process with each downlink resource allocation. Notably, while asynchronous HARQ increases signaling overhead, asynchronous HARQ increases flexibility since retransmissions do not have to be scheduled during specific slots.

A dynamic downlink resource allocation can be provided on a PDCCH using downlink control information (DCI) (e.g., DCI Format 1_0, DCI Format 1_1). DCI associated with a dynamic downlink resource allocation can include information that enables operation of downlink HARQ, such as information indicating a HARQ process number, a NDI, a redundancy version (RV), a PDSCH-to-HARQ feedback timing indicator, a PUCCH resource indicator, a downlink assignment index (DAI), code block group (CBG) transmission information (CBGTI), CBG flushing information (CBGFI), MCS information, or frequency resource allocation information (e.g., resource block allocation information), among other examples. Similarly, a dynamic uplink resource allocation can be provided on a PDCCH using DCI (e.g., DCI Format DCI Format 0_1). DCI associated with a dynamic uplink resource allocation can include information that enables operation of uplink HARQ, such as information indicating a HARQ process number, an NDI, an RV, or CBGTI.

With respect to downlink HARQ, an NDI may be communicated via a single bit used to inform a UE of whether the network node is transmitting a new transmission (e.g., a new transport block (TB)) or a retransmission of a previous transmission. Toggling the NDI value relative to a previous NDI value (e.g., from 0 to 1, from 1 to 0) for the same HARQ process indicates that a new transmission is being transmitted (rather than a retransmission). Conversely, maintaining (i.e., not toggling) the NDI value relative to a previous NDI value for the same HARQ process indicates that a retransmission is being transmitted (rather than a new transmission).

With respect to uplink HARQ, an NDI can be a one bit flag that serves as a HARQ acknowledgment for a previous transmission associated with the specified HARQ process number. For example, toggling the NDI value relative to a previous NDI value for the specified HARQ process serves to instruct the UE to initiate a new transmission (this corresponds to a positive acknowledgment of the previous transmission). Conversely, using the same NDI value (i.e., not toggling the NDI value relative to the previous NDI value) for the specified HARQ process serves to instruct the UE to perform a retransmission of the previous transmission (this corresponds to a negative acknowledgment of the previous transmission).

A state of a given HARQ process (herein referred to as a HARQ state) is defined by the NDI value and may include other information associated with performing HARQ transmission/reception, such as an MCS, a resource block (RB) allocation, timing information, or the like, associated with the HARQ process at a given time. Thus, a toggling of the NDI value relative to a previous NDI value can be said to cause a HARQ state of the HARQ process to switch from one HARQ state to another HARQ state (e.g., from a state 0 when the NDI value is 0 to a state 1 when the NDI value is 1, or vice versa).

According to a 3GPP specification, a UE may in some deployments not discard a HARQ state for a given HARQ process. That is, the UE may maintain a HARQ state for an indefinite amount of time. Notably, such operation does not account for the possibility that the UE and a network node can go out-of-sync with one another relatively easily since the NDI can be a single bit (for both downlink HARQ and uplink HARQ). Thus, as there are only two HARQ states (e.g., state 0 and state 1), the UE may easily miss a HARQ state change. For example, in the case of downlink HARQ, the UE may receive a first NDI indicating that a HARQ process is changing from a second state (e.g., state 1) to a first state (e.g., state 0). Therefore, the UE identifies an upcoming communication associated with the HARQ process as a new transmission. In this example, the UE receives and successfully decodes the new transmission (e.g., as scheduled by a PDCCH communication carrying the DCI including the first NDI). However, in this example, the UE fails to receive a second NDI that changes the state of the HARQ process from the first state to the second state, but later receives a third NDI indicating that the HARQ process is in the first state. In this scenario, the UE processes a communication associated with the third NDI as though the HARQ process remained in the first state, rather than operating as though the HARQ process transitioned from the first state to the second state and back to the first state. This results in the UE misidentifying another new transmission as a retransmission (of the previous new transmission) and the nw transmission being discarded by the UE.

Notably, in some deployments, a downlink HARQ entity may maintain a HARQ state for a given HARQ process for 256 slots (e.g., 256 milliseconds (ms) for NR 5G with a 15 kilohertz (kHz) subcarrier spacing (SCS)), after which the downlink HARQ entity may discard the HARQ state (e.g., if the HARQ state has not changed during the 256 slot time period). After discarding the HARQ state, any transmission is considered a new transmission. Before discarding the HARQ state, a determination of whether a given transmission is a new transmission or a retransmission is based on the value of the NDI, as described above. However, for periodic traffic with a periodicity lower than 256 slots (e.g., such as voice-over-NR (VoNR) traffic, which has a periodicity of 40 ms; or VR traffic, which may have a periodicity of 16.6 ms), such a configuration can still lead to a scenario in which a new transmission is discarded.

As an example, at a first point in time, a UE receives a first PDCCH communication carrying DCI including an NDI indicating a first state (e.g., state 0) for a HARQ process. In this example, the UE then receives and successfully decodes a new transmission (e.g., a first PDSCH communication) scheduled by the first PDCCH communication. Here, the UE starts a HARQ state discard timer with a duration of 256 ms after, for example, successfully decoding the new transmission. Next, the UE fails to receive a second PDCCH communication, transmitted at a second point (e.g., 40 ms after the first point in time), that carries DCI including an NDI indicating a second state (e.g., state 1) for the HARQ process. That is, the UE misses a HARQ state change and, therefore, misses a new transmission (e.g., a second PDSCH communication) associated with the HARQ process. Here, due to a discontinuous reception (DRX) configuration, the network may not attempt any retransmissions of the second PDCCH communication indicating the second state (e.g., with NDI=1) or the second PDSCH communication, assuming that the UE did not wake up from a sleep state as the UE failed to respond to the second PDCCH communication. Next, at a third point in time (e.g., 80 ms after the first point in time), the UE receives a third PDCCH communication carrying DCI including an NDI indicating the first state for a HARQ process. Here, the HARQ state is maintained by the UE since the first point in time (because the 256 slot timer has yet to expire). As a result, the UE misidentifies a new transmission (e.g., a third PDSCH communication scheduled by the third PDCCH communication) as a retransmission. Therefore, since the UE received and decoded the new transmission associated with the first PDCCH communication, the UE discards the third PDSCH communication scheduled by the third PDCCH communication, even though the third PDSCH communication is a new transmission (rather than a retransmission). Notably, in a scenario in which the UE fails to successfully decode the first PDSCH communication, the UE may attempt to combine the first PDSCH communication and the third PDSCH communication. (e.g., if DCI parameters permit combining) since the UE has misidentified the third PDSCH communication as a retransmission. However, such a combination is guaranteed to never succeed because the third PDSCH communication is a new transmission (rather than a retransmission). In either scenario, a result is that the UE improperly handles the third PDSCH communication.

Some aspects described herein provide techniques and apparatuses for HARQ state discarding. In some aspects, a UE may receive a first PDCCH communication having an NDI value for a HARQ process. In some aspects, the UE may start a HARQ state discard timer based at least in part on receiving the first PDCCH communication, with a duration of the HARQ state discard timer being based at least in part on one or more conditions. The one or more conditions may include, for example, a duration of a DRX cycle of the UE (e.g., a long DRX cycle of the UE, a short DRX cycle of the UE, or the like), a behavior of a network node with respect to communicating with the UE, a traffic pattern associated with the UE, a HARQ round trip time (RTT) associated with the network node, a sleep state of the UE, an SCS associated with the UE, a cell type associated with the network node, an application type associated with UE traffic, a set of quality of service (QoS) characteristics associated with the UE traffic, or a QoS identifier associated with the UE traffic, among other examples. In some aspects, the techniques and apparatuses for HARQ state discarding described herein may improve performance and reliability of HARQ operation. For example, the techniques and apparatuses for HARQ state discarding described herein may prevent a new transmission associated with periodic traffic from being improperly discarded or decoded as a result of being misidentified as a retransmission. Additional details are provided below.

FIGS. 3A and 3B are diagrams illustrating an example 300 associated with HARQ state discarding, in accordance with the present disclosure. As shown in FIG. 3A, example 300 includes communication between a network node 110 and a UE 120. In some aspects, the network node 110 and the UE 120 may be included in a wireless network, such as a wireless network 100. The network node 110 and the UE 120 may communicate via a wireless access link, which may include an uplink and a downlink.

As shown in FIG. 3A by reference 302, a network node 110 may transmit, and a UE 120 may receive, a PDCCH communication having an NDI for a HARQ process. For example, the network node 110 may transmit, and the UE 120 may receive, a PDCCH carrying DCI including an NDI value associated with a HARQ process of the UE 120, as described herein.

As shown by reference 304, the UE 120 may start a HARQ state discard timer based at least in part on receiving the PDCCH communication. For example, the PDCCH communication may schedule a PDSCH communication. Here, the UE 120 may attempt to receive and decode the PDSCH communication scheduled by the PDCCH communication having the NDI value. In one example, the UE 120 may fail to decode the PDSCH communication and may start the HARQ state discard timer based at least in part on failing to decode the PDSCH communication. In another example, the UE 120 may successfully decode the PDSCH communication and may start the PDSCH communication based at least in part on successfully decoding the PDSCH communication. In this way, in some aspects, the UE 120 may start the HARQ discard timer after receiving the PDCCH communication having the NDI value associated with the HARQ process.

In some aspects, a duration of the HARQ discard timer is based at least in part on one or more conditions. In some aspects, the one or more conditions include a duration of a DRX cycle of the UE 120 (e.g., a long DRX cycle of the UE, a short DRX cycle of the UE, or the like). That is, in some aspects, the duration of the HARQ state discard timer may be based at least in part on the DRX cycle of the UE 120. In some implementations, the UE 120 may determine the DRX cycle based at least in part on which the duration of the HARQ discard time is to be determined (e.g., a long DRX cycle or a short DRX cycle) based at least in part on, for example, a service type, or a relative length of the DRX cycles.

In operation, the UE 120 is awake (e.g., is not in a sleep state) during a portion of at each DRX cycle to enable PDCCH communication to be received by the UE 120. Here, by staying in the awake state for a number of DRX cycles, the UE 120 provides the network node 110 with an opportunity to schedule the UE 120 in a next DRX cycle (e.g., should the UE 120 fail to successfully receive or decode an earlier transmission). If a DRX on duration timer associated with the DRX cycle of the UE 120 is relatively short (e.g., shorter than a HARQ RTT), then the network node 110 has only one chance to schedule the UE 120 with a PDCCH communication and receive confirmation (e.g., via UE HARQ ACK/NACK feedback in the case of PDSCH, or via PUSCH) that the UE 120 successfully received the PDCCH communication. A successful reception of the PDCCH communication prolongs the DRX awake time, which provides opportunity for HARQ retransmissions. In some aspects, the duration of the HARQ state discard timer is equal to approximately two times the duration of the DRX cycle of the UE, minus a delay period. As one particular example, if the duration of the DRX cycle of the UE 120 is 40 ms (e.g., when the UE 120 is using a VoNR service) and a delay period is 10 ms, then the duration of the HARQ state discard timer is 70 ms (e.g., (2×40 ms)−10 ms=70 ms).

In some aspects, the duration of the HARQ state discard timer is longer than the duration of the DRX cycle of the UE. In some aspects, the duration of the HARQ state discard timer is shorter than N times the duration of the DRX cycle of the UE, where N is greater than or equal to 2. In some aspects, the duration of the HARQ state discard timer is greater than or equal to the duration of the DRX cycle of the UE plus the delay period. For example, if the duration of the DRX cycle of the UE 120 is 40 ms (e.g., when the UE 120 is using a VoNR service) and the delay period is 10 ms, then the duration of the HARQ state discard timer may be longer than 50 ms (e.g., at least 40 ms+10 ms=at least 50 ms).

In some aspects, the UE 120 may calculate the duration of the HARQ state discard timer. For example, the UE 120 may determine the duration of the DRX cycle of the UE 120, and may calculate the duration of the HARQ state discard timer based at least in part on the duration of the DRX cycle of the UE 120 (e.g., in the manner described in the example above).

In some aspects, a duration of the HARQ state discard timer may be a fixed value. For example, the duration of the HARQ discard timer may be a fixed value of X ms in a scenario in which the UE 120 is not configured with a DRX cycle or when the UE is configured for communication using a particular SCS (e.g., a 120 kHz SCS). In some aspects, a value of X may be based at least in part on a delay associated with one or more previous transmissions transmitted or received by the UE 120.

In some aspects, the duration of the HARQ state discard timer may be based at least in part on one or more conditions other than the duration of the DRX cycle of the UE 120. For example, in some aspects, the one or more conditions may include a behavior of a network node 110 with respect to communicating with the UE 120. For example, the UE 120 may be configured with a relatively long duration for the HARQ state discard timer. Here, the UE 120 may attempt to decode a shared channel communication as a retransmission when a corresponding PDCCH is received prior to expiration of the HARQ state discard timer. If the decoding fails (indicating that the duration of the HARQ state discard timer is too long), then the UE 120 may re-process the shared channel communication as a new transmission. If the UE 120 then successfully decodes the shared channel communication, the UE 120 may shorten the duration of the HARQ state discard timer (e.g., by a configured amount of time). In this way, the duration of the HARQ state discard timer can be dynamically adjusted over time until reaching an appropriate value for the particular network node 110.

As another example, the one or more conditions may in some aspects include a traffic pattern associated with the UE 120. For example, if the UE 120 has a relatively full buffer, then the UE 120 may use a comparatively shorter duration for the HARQ state discard timer and, conversely, use a comparatively longer duration for the HARQ state discard timer if the UE 120 has a relatively empty buffer. Here, the comparatively full buffer may prevent the UE 120 from entering a sleep state, and so the network node 110 has an opportunity to perform retransmissions, meaning that a comparatively shorter duration can be used. Conversely, the comparatively empty buffer may allow the UE 120 to enter a sleep state and, therefore, the network node 110 may have less opportunity to have a retransmission successfully received by the UE 120, and so a longer duration may be used. In some aspects, a duration of the HARQ state discard timer may be based at least in part on a traffic periodicity. For example, in some aspects, the duration of the HARQ state discard timer may be selected as a value equal to a multiple of the traffic periodicity (e.g., minus a delay period).

As another example, the one or more conditions may in some aspects include a HARQ RTT associated with the network node 110. For example, as noted above, HARQ is asynchronous and how a given HARQ retransmission is performed is up to a given network node 110 (e.g., a first network node 110 may be able to transmit a retransmission within 8 slots after an initial transmission, while a second network node 110 may need 14 slots after the initial transmission before being able to transmit the retransmission). In some aspects, the UE 120 may measure a HARQ RTT or determine a HARQ RTT configured by radio resource control (RRC) for DRX (e.g., drx-HARQ-RTT-TimerDL and drx-HARQ-RTT-TimerUL), and then set the duration of the HARQ state discard timer as a function of the HARQ RTT. In some aspects, if a DRX on duration timer (i.e., an amount of time that the UE 120 is awake for at each DRX cycle, irrespective of whether the UE 120 is scheduled) is longer than the HARQ RTT, then the UE 120 may determine that there is sufficient opportunity to retransmit within the first DRX awake occurring at the time of the first PDCCH communication. In such a scenario, the UE may select N to be a value of 1. If the network is determined to be under relatively heavy load, then the network node 110 may not be able to schedule the UE 120 in the next DRX cycle and, hence, the UE 120 may select N to be a value that is greater than 1.

As another example, the one or more conditions may in some aspects include a sleep state of the UE 120. For example, a first opportunity for a retransmission is within a HARQ RTT. Therefore, if the UE 120 is not in a sleep state at the HARQ RTT and the network node 110 did not transmit to the UE 120, this means that the network node 110 had an opportunity to transmit a retransmission to the UE 120, but did not do so. Here, if the UE 120 enters the sleep state after the HARQ RTT, it can be determined that the network node 110 did not want to schedule the UE 120 with a retransmission. Thus, in some aspects, the duration of the HARQ state discard timer may be based at least in part on whether the UE 120 is in a sleep state. In effect, in such a scenario, the duration of the HARQ state discard timer is set to zero. Rather, the HARQ state is based at least in part on whether the UE 120 has entered the sleep state after the HARQ RTT.

As another example, the one or more conditions may in some aspects include an SCS associated with the UE 120. That is, in some aspects, the duration of the HARQ state discard timer may be based at least in part on an SCS used by the UE 120. Notably, latency reduces as SCS increases (slots become shorter in time). Therefore, if the value of the HARQ state discard timer is represented in terms of milliseconds, the value of the HARQ state discard timer becomes smaller as SCS increases. Conversely, if the unit of the HARQ state discard timer is represented in terms of slots, the duration of the HARQ state discard timer may remain the same irrespective of an SCS used by the UE 120.

As another example, the one or more conditions may in some aspects include a cell type associated with the network node 110. That is, in some aspects, the duration of the HARQ state discard timer may be based at least in part on a type of a cell in which the network node 110 is communicating with the UE 120.

As another example, the one or more conditions may in some aspects include an application type associated with UE traffic. That is, in some aspects, the duration of the HARQ state discard timer maybe based at least in part on a type of application associated with traffic of the UE 120. For example, if the UE 120 is using a VoNR application, then the duration of the HARQ state discard timer may be based at least in part on a DRX cycle duration used by the UE 120 in association with the VoNR application.

As another example, the one or more conditions may in some aspects include a set of QoS characteristics associated with UE traffic. That is, in some aspects, the duration of the HARQ state discard timer may be based at least in part on QoS characteristics of traffic associated with the UE 120.

As another example, the one or more conditions may in some aspects include a QoS identifier associated with UE traffic (e.g., a 5G NR QoS identifier (5QI) associated with a traffic flow of the UE 120). That is, in some aspects, the duration of the HARQ state discard timer may be based at least in part on a QoS identifier associated with UE traffic.

As another example, the one or more conditions may in some aspects include a network type associated with the network node 110. That is, in some aspects, the duration of the HARQ state discard timer may be based at least in part on a type of network associated with the network node 110. For example, in a scenario in which the network node 110 is included in a terrestrial network (TN), an RTT (and therefore a latency) is comparatively shorter, and so the duration of the HARQ state discard timer may be comparatively shorter. Conversely, in a scenario in which the network node 110 is included in a non-terrestrial network (NTN), the RTT (and therefore the latency) may be comparatively longer, and so the duration of the HARQ state discard timer may be comparatively longer.

In some aspects, as noted above, the duration of the HARQ state discard timer is further based at least in part on a delay period. The delay period may be used to account for network characteristics or UE characteristics that could cause delay with respect to transmission and reception of communications between the network node 110 and the UE 120. For example, the delay period may be used to account for scheduling delay, a UE wake-up delay, jitter, or a period of a semi-persistent scheduling (SPS) grant. Therefore, in some aspects, the delay period may be based at least in part on a scheduling delay (e.g., an expected or estimated scheduling delay), a UE wake-up delay (e.g., an expected or estimated UE wake-up delay), jitter (e.g., an expected or estimated jitter), or a period of an SPS grant.

In some aspects, the UE 120 may determine the duration of the HARQ state discard timer based at least in part on comparing a first HARQ state discard timer value (e.g., a HARQ state discard timer value calculated by the UE 120) and a second HARQ state discard timer value (e.g., a HARQ state discard timer value configured on the UE 120 by the network node 110). For example, the UE 120 may determine a first HARQ state discard timer duration value based at least in part on the one or more conditions, as described herein. In one example, the UE 120 determines the first HARQ state discard timer value as 70 ms (e.g., based at least in part on the DRX cycle duration of the UE 120). Next, the UE 120 determines whether the first HARQ state discard timer duration value is less than or equal to a second HARQ state discard timer duration value. In this example, the second HARQ state discard timer value is 256 ms (e.g., a HARQ state discard timer value configured on the UE 120 by the network node 110). Here, the UE 120 may identify the duration of the HARQ state as the first HARQ state discard timer duration value (e.g., 70 ms) based at least in part on a determination that the first HARQ state discard timer duration value is less than or equal to the second HARQ state discard timer duration value (e.g., 256 ms). Thus, in some aspects, the UE 120 may identify a minimum of a first HARQ state discard timer value and a second HARQ state discard timer value, and determine the HARQ state discard timer value as the minimum of the first HARQ state discard timer value and the second HARQ state discard timer value.

In some aspects, the UE 120 may set the HARQ state discard timer according to the duration of the HARQ state discard timer. That is, the UE 120 may determine the duration of the HARQ state discard timer, and may set the HARQ state discard timer such that the HARQ state discard timer is configured to use the HARQ state discard timer value determined by the UE 120.

In some aspect, the UE 120 may receive a configuration indicating the duration of the HARQ state discard timer from the network node 110. That is, in some aspects, the one or more conditions include a configuration received from a network node 110. Put another way, in some aspects, the network node 110 may configure the UE 120 with a value for the HARQ state discard timer. In some aspects, the UE 120 may be configured with separate (e.g., different) values for uplink HARQ and downlink HARQ. In some aspects, configuration of the UE 120 by the network node 110 may enable a value most suited to the specific operation of the network to be used for the HARQ state discard timer.

In some aspects, the UE 120 may discard the HARQ state in association with the HARQ state discard timer and in association with checking an RV. For example, the UE 120 may check for an expiration of the HARQ state discard timer only if the RV is zero (RV=0), the NDI is the same as a previous NDI, and a non-reserved MCS satisfies an MCS threshold. In some aspects, the UE 120 may discard the HARQ state in association with the HARQ state discard timer and in association with a previously received DCI having a non-reserved MCS and an NDI value that is equal to a current NDI value. In some aspects, the UE 120 may discard the HARQ state in association with the HARQ state discard timer and in association with the network node 110 having previously used an RV value that is not equal to zero (RV !=0) for a new transmission.

In some aspects, the UE 120 may discard the HARQ state in association with checking one or more parameters from a received DCI (e.g., an MCS, an RV, or the like) and one or more other resource allocation parameters, such as a number of symbols or a number of RBs. For example, if the RV is 0 or if the RV !=0, but the MCS fails to satisfy (e.g., is lower than) a threshold, and the resource allocation parameter satisfies a threshold, then the UE 120 may determine that a transport block (TB) is self-decodable and may discard the HARQ state in association with the HARQ state discard timer. In an alternative example, if the RV !=0 and the MCS satisfies (e.g., is equal to or higher than) the threshold, then the UE 120 may determine that the TB is not self-decodable and may refrain from discarding the HARQ state.

In some aspects, the UE 120 may selectively discard the HARQ state in association with DCI misdetection information. The DCI misdetection information may indicate a likelihood that the UE 120 did not receive first DCI from the network node 110. For example, in association with the UE 120 determining that the likelihood is high (e.g., greater than a threshold), the UE 120 may determine to discard the HARQ state. Alternatively, in association with the UE 120 determining that the likelihood is low (e.g., not greater than the threshold), the UE 120 may determine to not discard the HARQ state.

In some aspects, the DCI misdetection information may be in association with PDCCH decoding metrics, such as an energy parameter (for example, energy detected), a cyclic redundancy check (CRC) parameter (e.g., a CRC fail), or a prune parameter, among other examples. In some aspects, the DCI misdetection information may be in association with a measurement gap. For example, the UE 120 may determine whether a measurement gap has occurred and may determine whether the network node 110 is performing scheduling during the measurement gap. In some aspects, the DCI misdetection information may be in association with a pattern of one or more previous RVs. For example, the UE 120 may determine whether a transmission is to be a retransmission or a new transmission in association with the pattern of the one or more previous RVs.

In some aspects, after receiving a first PDCCH communication (e.g., the PDCCH communication received as shown by reference 302) and starting the HARQ state discard timer, the UE 120 may receive a second PDCCH communication having the NDI value (e.g., the same NDI value, such as 0 or 1) for the HARQ process. In some aspects, if the second PDCCH communication is received prior to an expiration of the HARQ state discard timer, then the UE 120 may process a shared channel communication (e.g., a PDSCH communication) scheduled by the second PDCCH communication as a retransmission. That is, the UE 120 may process the shared channel communication as a retransmission based at least in part on the second PDCCH communication being received prior to the expiration of the HARQ state discard timer.

Conversely, if the second PDCCH communication is received after an expiration of the HARQ state discard timer, then the UE 120 may process the shared channel communication scheduled by the second PDCCH communication as a new transmission. That is, the UE 120 may process the shared channel communication as a new transmission based at least in part on the second PDCCH communication being received after the expiration of the HARQ state discard timer.

FIG. 3B is a diagram illustrating an example 350 in which the UE 120 processes a shared channel communication as a new transmission based at least in part on a second PDCCH communication being received after an expiration of a HARQ state discard timer. As shown in FIG. 3B by reference 352, at a first point in time (e.g., 0 ms), a UE 120 receives a first PDCCH communication (e.g., a new downlink grant) having a first NDI value (e.g., NDI 0) for a HARQ process (e.g., HARQ process 1).

As shown by reference 354, the UE 120 starts a HARQ state discard timer based at least in part on receiving the first PDCCH communication. In this example, as indicated in FIG. 3B, the duration of the HARQ state discard timer is 70 ms (e.g., two times a 40 ms duration of a DRX cycle duration of the UE 120, minus a 10 ms delay period). As shown by reference 356, at a second point in time (e.g., 40 ms), the UE 120 misses a PDCCH communication (e.g., a new downlink grant) having a second NDI value (e.g., NDI 1) for the HARQ process.

As shown by reference 358, at a third point in time (e.g., 80 ms), the UE 120 receives a second PDCCH communication (e.g., a new downlink grant) having the first NDI value (e.g., NDI 0) for the HARQ process. As indicated in FIG. 3B, the HARQ state discard timer has expired prior to the reception of the second PDCCH communication and, therefore, the UE 120 processes a PDSCH communication associated with the second PDCCH communication as a new transmission based at least in part on the second PDCCH communication being received after the expiration of the HARQ state discard timer. Notably, if the duration of the HARQ state discard timer was longer than two times the DRX cycle duration in this example (or if the UE 120 maintained the HARQ state indefinitely), then the UE 120 would have improperly discarded the PDSCH communication associated with the second PDCCH communication.

As indicated above, FIGS. 3A and 3B are provided as examples. Other examples may differ from what is described with respect to FIGS. 3A and 3B.

FIG. 4 is a diagram illustrating an example process 400 performed, for example, by a UE, in accordance with the present disclosure. Example process 400 is an example where the UE (e.g., UE 120) performs operations associated with techniques for HARQ state discarding.

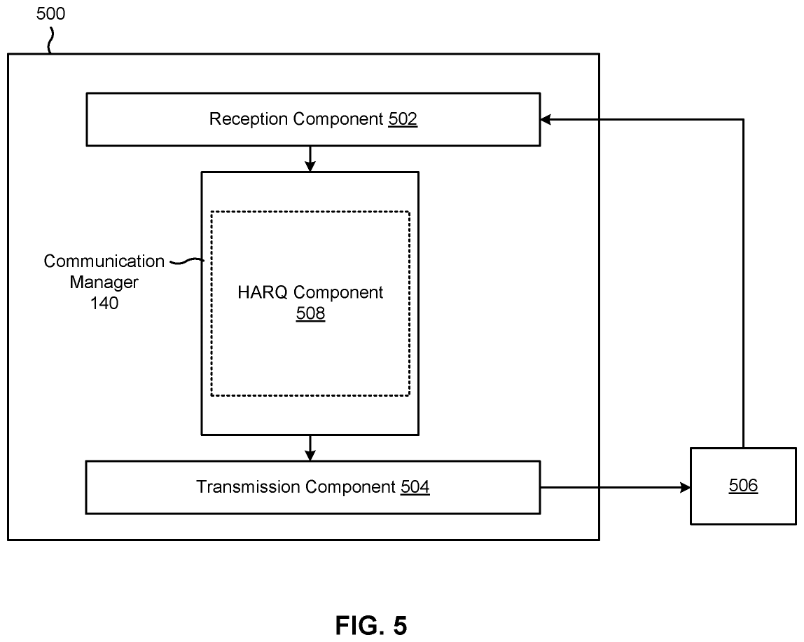

As shown in FIG. 4, in some aspects, process 400 may include receiving a first PDCCH communication having an NDI value for a HARQ process (block 410). For example, the UE (e.g., using communication manager 140 and/or reception component 502, depicted in FIG. 5) may receive a first PDCCH communication having an NDI value for a HARQ process, as described above.

As further shown in FIG. 4, in some aspects, process 400 may include starting a HARQ state discard timer based at least in part on receiving the first PDCCH communication, wherein a duration of the HARQ state discard timer is based at least in part on one or more conditions (block 420). For example, the UE (e.g., using communication manager 140 and/or HARQ component 508, depicted in FIG. 5) may start a HARQ state discard timer based at least in part on receiving the first PDCCH communication, wherein a duration of the HARQ state discard timer is based at least in part on one or more conditions, as described above.

Process 400 may include additional aspects, such as any single aspect or any combination of aspects described below and/or in connection with one or more other processes described elsewhere herein.

In a first aspect, the one or more conditions include a duration of a DRX cycle of the UE.

In a second aspect, alone or in combination with the first aspect, the duration of the HARQ state discard timer is longer than the duration of the DRX cycle of the UE.

In a third aspect, alone or in combination with one or more of the first and second aspects, the duration of the HARQ state discard timer is shorter than N times the duration of the DRX cycle of the UE, wherein N is greater than or equal to 2.

In a fourth aspect, alone or in combination with one or more of the first through third aspects, the duration of the HARQ state discard timer is equal to approximately two times the duration of the DRX cycle of the UE, minus a delay period.

In a fifth aspect, alone or in combination with one or more of the first through fourth aspects, the duration of the HARQ state discard timer is greater than or equal to the duration of the DRX cycle of the UE plus a delay period.

In a sixth aspect, alone or in combination with one or more of the first through fifth aspects, process 400 includes determining the duration of the DRX cycle of the UE, and calculating the duration of the HARQ state discard timer based at least in part on the duration of the DRX cycle of the UE.

In a seventh aspect, alone or in combination with one or more of the first through sixth aspects, the duration of the DRX cycle of the UE is 40 ms and the duration of the HARQ state discard timer is 70 ms.

In an eighth aspect, alone or in combination with one or more of the first through seventh aspects, the duration of the HARQ state discard timer is further based at least in part on a delay period.

In a ninth aspect, alone or in combination with one or more of the first through eighth aspects, a duration of the delay period is based at least in part on at least one of a scheduling delay, a UE wake-up delay, jitter or a period of an SPS grant.

In a tenth aspect, alone or in combination with one or more of the first through ninth aspects, process 400 includes receiving a second PDCCH communication having the NDI value for the HARQ process, the second PDCCH communication being received prior to an expiration of the HARQ state discard timer, and processing a shared channel communication scheduled by the second PDCCH communication as a retransmission based at least in part on the second PDCCH communication being received prior to the expiration of the HARQ state discard timer.

In an eleventh aspect, alone or in combination with one or more of the first through tenth aspects, process 400 includes receiving a second PDCCH communication having the NDI value for the HARQ process, the second PDCCH communication being received after an expiration of the HARQ state discard timer, and processing a shared channel communication scheduled by the second PDCCH communication as a new transmission based at least in part on the second PDCCH communication being received after the expiration of the HARQ state discard timer.

In a twelfth aspect, alone or in combination with one or more of the first through eleventh aspects, process 400 includes determining a first HARQ state discard timer duration value based at least in part on the one or more conditions, determining that the first HARQ state discard timer duration value is less than or equal to a second HARQ state discard timer duration value, and identifying the duration of the HARQ state as the first HARQ state discard timer duration value based at least in part on the determination that the first HARQ state discard timer duration value is less than or equal to a second HARQ state discard timer duration value.

In a thirteenth aspect, alone or in combination with one or more of the first through twelfth aspects, process 400 includes setting the HARQ state discard timer according to the duration of the HARQ state discard timer.

In a fourteenth aspect, alone or in combination with one or more of the first through thirteenth aspects, the one or more conditions include a behavior of a network node with respect to communicating with the UE.

In a fifteenth aspect, alone or in combination with one or more of the first through fourteenth aspects, the one or more conditions include a traffic pattern associated with the UE.

In a sixteenth aspect, alone or in combination with one or more of the first through fifteenth aspects, the one or more conditions include a HARQ RTT associated with a network node.

In a seventeenth aspect, alone or in combination with one or more of the first through sixteenth aspects, the one or more conditions include a sleep state of the UE.

In an eighteenth aspect, alone or in combination with one or more of the first through seventeenth aspects, the one or more conditions include a subcarrier spacing associated with the UE.

In a nineteenth aspect, alone or in combination with one or more of the first through eighteenth aspects, the one or more conditions include a cell type associated with a network node.

In a twentieth aspect, alone or in combination with one or more of the first through nineteenth aspects, the one or more conditions include an application type associated with UE traffic.

In a twenty-first aspect, alone or in combination with one or more of the first through twentieth aspects, the one or more conditions include a set of quality of service characteristics associated with UE traffic.

In a twenty-second aspect, alone or in combination with one or more of the first through twenty-first aspects, the one or more conditions include a quality of service identifier associated with UE traffic.

In a twenty-third aspect, alone or in combination with one or more of the first through twenty-second aspects, the one or more conditions include a configuration received from a network node.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram of an example apparatus 500 for wireless communication, in accordance with the present disclosure. The apparatus 500 may be a UE, or a UE may include the apparatus 500. In some aspects, the apparatus 500 includes a reception component 502 and a transmission component 504, which may be in communication with one another (for example, via one or more buses and/or one or more other components). As shown, the apparatus 500 may communicate with another apparatus 506 (such as a UE, a base station, or another wireless communication device) using the reception component 502 and the transmission component 504. As further shown, the apparatus 500 may include the communication manager 140. The communication manager 140 may include a HARQ component 508, among other examples.

In some aspects, the apparatus 500 may be configured to perform one or more operations described herein in connection with FIGS. 3A and 3B. Additionally, or alternatively, the apparatus 500 may be configured to perform one or more processes described herein, such as process 400 of FIG. 4. In some aspects, the apparatus 500 and/or one or more components shown in FIG. 5 may include one or more components of the UE described in connection with FIG. 2. Additionally, or alternatively, one or more components shown in FIG. 5 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 502 may receive communications, such as reference signals, control information, data communications, or a combination thereof, from the apparatus 506. The reception component 502 may provide received communications to one or more other components of the apparatus 500. In some aspects, the reception component 502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 500. In some aspects, the reception component 502 may include one or more antennas, a modem, a demodulator, a MIMO detector, a receive processor, a controller/processor, a memory, or a combination thereof, of the UE described in connection with FIG. 2.

The transmission component 504 may transmit communications, such as reference signals, control information, data communications, or a combination thereof, to the apparatus 506. In some aspects, one or more other components of the apparatus 500 may generate communications and may provide the generated communications to the transmission component 504 for transmission to the apparatus 506. In some aspects, the transmission component 504 may perform signal processing on the generated communications (such as filtering, amplification, modulation, digital-to-analog conversion, multiplexing, interleaving, mapping, or encoding, among other examples), and may transmit the processed signals to the apparatus 506. In some aspects, the transmission component 504 may include one or more antennas, a modem, a modulator, a transmit MIMO processor, a transmit processor, a controller/processor, a memory, or a combination thereof, of the UE described in connection with FIG. 2. In some aspects, the transmission component 504 may be co-located with the reception component 502 in a transceiver.

The reception component 502 may receive a first PDCCH communication having an NDI value for a HARQ process. The HARQ component 508 may start a HARQ state discard timer based at least in part on receiving the first PDCCH communication, wherein a duration of the HARQ state discard timer is based at least in part on one or more conditions.

The HARQ component 508 may determine the duration of the DRX cycle of the UE. The HARQ component 508 may calculate the duration of the HARQ state discard timer based at least in part on the duration of the DRX cycle of the UE.

The reception component 502 may receive a second PDCCH communication having the NDI value for the HARQ process, the second PDCCH communication being received prior to an expiration of the HARQ state discard timer. The HARQ component 508 may process a shared channel communication scheduled by the second PDCCH communication as a retransmission based at least in part on the second PDCCH communication being received prior to the expiration of the HARQ state discard timer.

The reception component 502 may receive a second PDCCH communication having the NDI value for the HARQ process, the second PDCCH communication being received after an expiration of the HARQ state discard timer. The HARQ component 508 may process a shared channel communication scheduled by the second PDCCH communication as a new transmission based at least in part on the second PDCCH communication being received after the expiration of the HARQ state discard timer.

The HARQ component 508 may determine a first HARQ state discard timer duration value based at least in part on the one or more conditions. The HARQ component 508 may determine that the first HARQ state discard timer duration value is less than or equal to a second HARQ state discard timer duration value. The HARQ component 508 may identify the duration of the HARQ state as the first HARQ state discard timer duration value based at least in part on the determination that the first HARQ state discard timer duration value is less than or equal to a second HARQ state discard timer duration value.

The HARQ component 508 may set the HARQ state discard timer according to the duration of the HARQ state discard timer.

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally, or alternatively, a set of (one or more) components shown in FIG. 5 may perform one or more functions described as being performed by another set of components shown in FIG. 5.

The following provides an overview of some Aspects of the present disclosure:

Aspect 1: A method of wireless communication performed by a UE, comprising: receiving a first PDCCH communication having an NDI value for a HARQ process; and starting a HARQ state discard timer based at least in part on receiving the first PDCCH communication, wherein a duration of the HARQ state discard timer is based at least in part on one or more conditions.

Aspect 2: The method of Aspect 1, wherein the one or more conditions include a duration of a DRX cycle of the UE.

Aspect 3: The method of Aspect 2, wherein the duration of the HARQ state discard timer is longer than the duration of the DRX cycle of the UE.

Aspect 4: The method of any of Aspects 2-3, wherein the duration of the HARQ state discard timer is shorter than N times the duration of the DRX cycle of the UE, wherein N is greater than or equal to 2.

Aspect 5: The method of any of Aspects 2-4, wherein the duration of the HARQ state discard timer is equal to approximately two times the duration of the DRX cycle of the UE, minus a delay period.

Aspect 6: The method of any of Aspects 2-5, wherein the duration of the HARQ state discard timer is greater than or equal to the duration of the DRX cycle of the UE plus a delay period.

Aspect 7: The method of any of Aspects 2-6, further comprising: determining the duration of the DRX cycle of the UE; and calculating the duration of the HARQ state discard timer based at least in part on the duration of the DRX cycle of the UE.

Aspect 8: The method of any of Aspects 2-7, wherein the duration of the DRX cycle of the UE is 40 ms and the duration of the HARQ state discard timer is 70 ms.

Aspect 9: The method of any of Aspects 1-8, wherein the duration of the HARQ state discard timer is further based at least in part on a delay period.

Aspect 10: The method of Aspect 9, wherein a duration of the delay period is based at least in part on at least one of a scheduling delay, a UE wake-up delay, jitter, or a period of an SPS grant.

Aspect 11: The method of any of Aspects 1-10, further comprising: receiving a second PDCCH communication having the NDI value for the HARQ process, the second PDCCH communication being received prior to an expiration of the HARQ state discard timer, and processing a shared channel communication scheduled by the second PDCCH communication as a retransmission based at least in part on the second PDCCH communication being received prior to the expiration of the HARQ state discard timer.

Aspect 12: The method any of Aspects 1-10, further comprising: receiving a second PDCCH communication having the NDI value for the HARQ process, the second PDCCH communication being received after an expiration of the HARQ state discard timer, and processing a shared channel communication scheduled by the second PDCCH communication as a new transmission based at least in part on the second PDCCH communication being received after the expiration of the HARQ state discard timer.

Aspect 13: The method of any of Aspects 1-12, further comprising: determining a first HARQ state discard timer duration value based at least in part on the one or more conditions; determining that the first HARQ state discard timer duration value is less than or equal to a second HARQ state discard timer duration value; and identifying the duration of the HARQ state as the first HARQ state discard timer duration value based at least in part on the determination that the first HARQ state discard timer duration value is less than or equal to a second HARQ state discard timer duration value.

Aspect 14: The method of any of Aspects 1-13, further comprising setting the HARQ state discard timer according to the duration of the HARQ state discard timer.

Aspect 15: The method of any of Aspects 1-14, wherein the one or more conditions include a behavior of a network node with respect to communicating with the UE.

Aspect 16: The method of any of Aspects 1-15, wherein the one or more conditions include a traffic pattern associated with the UE.

Aspect 17: The method of any of Aspects 1-16, wherein the one or more conditions include a HARQ RTT associated with a network node.

Aspect 18: The method of any of Aspects 1-17, wherein the one or more conditions include a sleep state of the UE.

Aspect 19: The method of any of Aspects 1-18, wherein the one or more conditions include a subcarrier spacing associated with the UE.

Aspect 20: The method of any of Aspects 1-19, wherein the one or more conditions include a cell type associated with a network node.

Aspect 21: The method of any of Aspects 1-20, wherein the one or more conditions include an application type associated with UE traffic.

Aspect 22: The method of any of Aspects 1-21, wherein the one or more conditions include a set of quality of service characteristics associated with UE traffic.

Aspect 23: The method of any of Aspects 1-22, wherein the one or more conditions include a quality of service identifier associated with UE traffic.

Aspect 24: The method of any of Aspects 1-23, wherein the one or more conditions include a configuration received from a network node.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving a first physical downlink control channel (PDCCH) communication having a new data indicator (NDI) value for a hybrid automatic repeat request (HARQ) process; and
starting a HARQ state discard timer based at least in part on receiving the first PDCCH communication,
wherein a duration of the HARQ state discard timer is based at least in part on one or more conditions.

2. The method of claim 1, wherein the one or more conditions include a duration of a discontinuous reception (DRX) cycle of the UE.

3. The method of claim 2, wherein the duration of the HARQ state discard timer is longer than the duration of the DRX cycle of the UE.

4. The method of claim 2, wherein the duration of the HARQ state discard timer is shorter than N times the duration of the DRX cycle of the UE, wherein N is greater than or equal to 2.

5. The method of claim 2, wherein the duration of the HARQ state discard timer is equal to approximately two times the duration of the DRX cycle of the UE, minus a delay period.

6. The method of claim 2, wherein the duration of the HARQ state discard timer is greater than or equal to the duration of the DRX cycle of the UE plus a delay period.

7. The method of claim 2, further comprising:
determining the duration of the DRX cycle of the UE; and
calculating the duration of the HARQ state discard timer based at least in part on the duration of the DRX cycle of the UE.

8. The method of claim 2, wherein the duration of the DRX cycle of the UE is 40 milliseconds (ms) and the duration of the HARQ state discard timer is 70 ms.

9. The method of claim 1, wherein the duration of the HARQ state discard timer is further based at least in part on a delay period, wherein a duration of the delay period is based at least in part on at least one of a scheduling delay, a UE wake-up delay, jitter, or a period of a semi-persistent scheduling (SPS) grant.

10. The method of claim 1, further comprising:
receiving a second PDCCH communication having the NDI value for the HARQ process, the second PDCCH communication being received prior to an expiration of the HARQ state discard timer, and
processing a shared channel communication scheduled by the second PDCCH communication as a retransmission based at least in part on the second PDCCH communication being received prior to the expiration of the HARQ state discard timer.

11. The method of claim 1, further comprising:
receiving a second PDCCH communication having the NDI value for the HARQ process, the second PDCCH communication being received after an expiration of the HARQ state discard timer, and
processing a shared channel communication scheduled by the second PDCCH communication as a new transmission based at least in part on the second PDCCH communication being received after the expiration of the HARQ state discard timer.

12. The method of claim 1, further comprising:
determining a first HARQ state discard timer duration value based at least in part on the one or more conditions;
determining that the first HARQ state discard timer duration value is less than or equal to a second HARQ state discard timer duration value; and
identifying the duration of the HARQ state as the first HARQ state discard timer duration value based at least in part on the determination that the first HARQ state discard timer duration value is less than or equal to a second HARQ state discard timer duration value.

13. The method of claim 1, further comprising setting the HARQ state discard timer according to the duration of the HARQ state discard timer.

14. The method of claim 1, wherein the one or more conditions include at least one of:
a behavior of a network node with respect to communicating with the UE,
a traffic pattern associated with the UE,
a HARQ round trip time (RTT) associated with the network node,
a sleep state of the UE,
a subcarrier spacing associated with the UE,
a cell type associated with the network node,
an application type associated with UE traffic,
a set of quality of service characteristics associated with the UE traffic,
a quality of service identifier associated with the UE traffic, or
a configuration received from the network node.

15. A user equipment (UE) for wireless communication, comprising:
a memory; and
one or more processors, coupled to the memory, configured to:
receive a first physical downlink control channel (PDCCH) communication having a new data indicator (NDI) value for a hybrid automatic repeat request (HARQ) process; and
start a HARQ state discard timer based at least in part on receiving the first PDCCH communication,
wherein a duration of the HARQ state discard timer is based at least in part on one or more conditions.

16. The UE of claim 15, wherein the one or more conditions include a duration of a discontinuous reception (DRX) cycle of the UE.

17. The UE of claim 16, wherein the duration of the HARQ state discard timer is longer than the duration of the DRX cycle of the UE.

18. The UE of claim 16, wherein the duration of the HARQ state discard timer is shorter than N times the duration of the DRX cycle of the UE, wherein N is greater than or equal to 2.

19. The UE of claim 16, wherein the duration of the HARQ state discard timer is equal to approximately two times the duration of the DRX cycle of the UE, minus a delay period.

20. The UE of claim 16, wherein the duration of the HARQ state discard timer is greater than or equal to the duration of the DRX cycle of the UE plus a delay period.

21. The UE of claim 16, wherein the one or more processors are further configured to:
determine the duration of the DRX cycle of the UE; and
calculate the duration of the HARQ state discard timer based at least in part on the duration of the DRX cycle of the UE.

22. The UE of claim 16, wherein the duration of the DRX cycle of the UE is 40 milliseconds (ms) and the duration of the HARQ state discard timer is 70 ms.

23. The UE of claim 15, wherein the duration of the HARQ state discard timer is further based at least in part on a delay period, wherein a duration of the delay period is based at least in part on at least one of a scheduling delay, a UE wake-up delay, jitter, or a period of a semi-persistent scheduling (SPS) grant.

24. The UE of claim 15, wherein the one or more processors are further configured to:
receive a second PDCCH communication having the NDI value for the HARQ process, the second PDCCH communication being received prior to an expiration of the HARQ state discard timer, and
process a shared channel communication scheduled by the second PDCCH communication as a retransmission based at least in part on the second PDCCH communication being received prior to the expiration of the HARQ state discard timer.

25. The UE of claim 15, wherein the one or more processors are further configured to:
receive a second PDCCH communication having the NDI value for the HARQ process, the second PDCCH communication being received after an expiration of the HARQ state discard timer, and
process a shared channel communication scheduled by the second PDCCH communication as a new transmission based at least in part on the second PDCCH communication being received after the expiration of the HARQ state discard timer.

26. The UE of claim 15, wherein the one or more processors are further configured to:
determine a first HARQ state discard timer duration value based at least in part on the one or more conditions;
determine that the first HARQ state discard timer duration value is less than or equal to a second HARQ state discard timer duration value; and
identify the duration of the HARQ state as the first HARQ state discard timer duration value based at least in part on the determination that the first HARQ state discard timer duration value is less than or equal to a second HARQ state discard timer duration value.

27. The UE of claim 15, wherein the one or more processors are further configured to set the HARQ state discard timer according to the duration of the HARQ state discard timer.

28. The UE of claim 15, wherein the one or more conditions include at least one of:
a behavior of a network node with respect to communicating with the UE,
a traffic pattern associated with the UE,
a HARQ round trip time (RTT) associated with the network node,
a sleep state of the UE,
a subcarrier spacing associated with the UE,
a cell type associated with the network node,
an application type associated with UE traffic,
a set of quality of service characteristics associated with the UE traffic,
a quality of service identifier associated with the UE traffic, or
a configuration received from the network node.

29. A non-transitory computer-readable medium storing a set of instructions for wireless communication, the set of instructions comprising:
one or more instructions that, when executed by one or more processors of a user equipment (UE), cause the UE to:
receive a first physical downlink control channel (PDCCH) communication having a new data indicator (NDI) value for a hybrid automatic repeat request (HARQ) process; and
start a HARQ state discard timer based at least in part on receiving the first PDCCH communication,
wherein a duration of the HARQ state discard timer is based at least in part on one or more conditions.

30. An apparatus for wireless communication, comprising:
means for receiving a first physical downlink control channel (PDCCH) communication having a new data indicator (NDI) value for a hybrid automatic repeat request (HARQ) process; and
means for starting a HARQ state discard timer based at least in part on receiving the first PDCCH communication,
wherein a duration of the HARQ state discard timer is based at least in part on one or more conditions.
